(19) United States
(12) Patent Application Publication
(10) Pub. No.: US 2017/0229785 A1
(43) Pub. Date: Aug. 10, 2017

(54) STADIUM ANTENNA

(71) Applicant: CommScope Technologies LLC, Hickory, NC (US)

(72) Inventors: Wei FU, Baulkham Hills (AU); Dushmantha N P THALAKOTUNA, Rosehill (AU); Peter John LIVERSIDGE, Glenbrook (AU)

(21) Appl. No.: 15/502,853

(22) PCT Filed: Dec. 17, 2014
(86) PCT No.: PCT/AU2014/001138

§ 371 Date: Feb. 9, 2017

(30) Foreign Application Priority Data
Oct. 10, 2014 (AU) 2014904064

(51) Int. Cl. H01Q 21/26; H01Q 21/06

(52) U.S. Cl. CPC H01Q 21/26; H01Q 21/062; H01Q 21/065

(57) ABSTRACT

Antennas are provided that can produce a rectangular radiation pattern for use in a stadium. The antenna includes a ground plane, a feed network, and at least two arrays of radiating elements. Each array is fed by a respective one of the two or more sets of outputs of the feed network for producing the rectangular radiation pattern in a respective one of a plurality of frequency bands. The at least two arrays of radiating elements are suspended above one side of the ground plane, while the feed network feeding the at least two arrays are on the other side of the ground plane.

### RELATED APPLICATION

The present application claims the benefit of the earlier filing date of Australian Provisional Patent Application No. 2014904064 in the name of Andrew LLC, filed on 10 Oct. 2014, the content of which is incorporated herein by reference in its entirety.

### TECHNICAL FIELD

The present invention relates generally to antennas and, in particular, to a dual polarization antenna that produces a rectangular radiation pattern for use in a stadium.

### BACKGROUND

Stadiums and other large venues require high capacity antennas to cater for the high number of mobile users during events. Conventional base station antennas can be used for such a purpose, but requires installation of additional antennas. However, installing additional antennas on base stations is not efficient, due to wasted spectrum, coverage overlap, and poor quality of service.

Thus, a need exists to provide an antenna having a high capacity and efficient use of spectrum.

### SUMMARY

Disclosed is an antenna which seeks to address the above problems by having a targeted radiation pattern, as well as low side lobes and high front to back (F/B) radiation ratio. The disclosed antenna is also capable of multiple-inputs multiple-outputs (MIMO) functionality.

According to a first aspect of the present disclosure, there is provided an antenna for use in a stadium capable of producing a rectangular radiation pattern, the antenna comprising: a ground plane; a feed network for processing, radio-frequency (RF) signals in a plurality of frequency bands to or from two or more sets of antenna feeds, each set of antenna feeds providing or receiving RF signals on a respective one of the plurality of frequency bands; at least two arrays of radiating elements, each array being fed by a respective one of the two or more sets of antenna feeds of the feed network for producing the rectangular radiation pattern in a respective one of the plurality of frequency bands, each array comprising a plurality of dual polarization radiating elements for producing dual, polarization of the rectangular radiation pattern, the at least two arrays of radiating elements being suspended above one side of the ground plane, the feed network feeding the at least two arrays on the other side of the ground plane.

Other aspects of the invention are also disclosed.

### BRIEF DESCRIPTION OF THE DRAWINGS

At least one embodiment of the present invention is described hereinafter with reference to the drawings and, appendices, in which:

FIG. 1 is a block diagram of an antenna according to an embodiment of the present invention:

FIGS. 2A and 2B show a perspective and top views, respectively, of arrays of radiating elements of the antenna shown in FIG. 1;

FIGS. 3A to 3F are perspective and side views of the radiating elements of the arrays shown in FIGS. 2A and 2B;

FIGS. 4A and 4B are schematic block diagrams of different implementations of a first part of a feed network of the antenna shown in FIG. 1;

FIG. 5 is a schematic block diagram showing an implementation of a second part of the feed network of the antenna shown in FIG. 1;

FIG. 6 is a plot displaying am example of a radiation pattern of the antenna shown in FIG. 1; and

FIG. 7 is a block diagram illustrating the amplitude and phase distributions within a 5×5 array to provide a rectangular radiation pattern.

### DETAILED DESCRIPTION

Where reference is made in any one or more of the accompanying drawings to features, which have the same reference numerals, those features have for the purposes of this description the same function(s), unless the contrary intention appears.

It is to be noted that the discussions contained in the “Background” section should not be interpreted as a representation by the present inventor(s) or the patent applicant that such discussion in any way form part of the common general knowledge in the art.

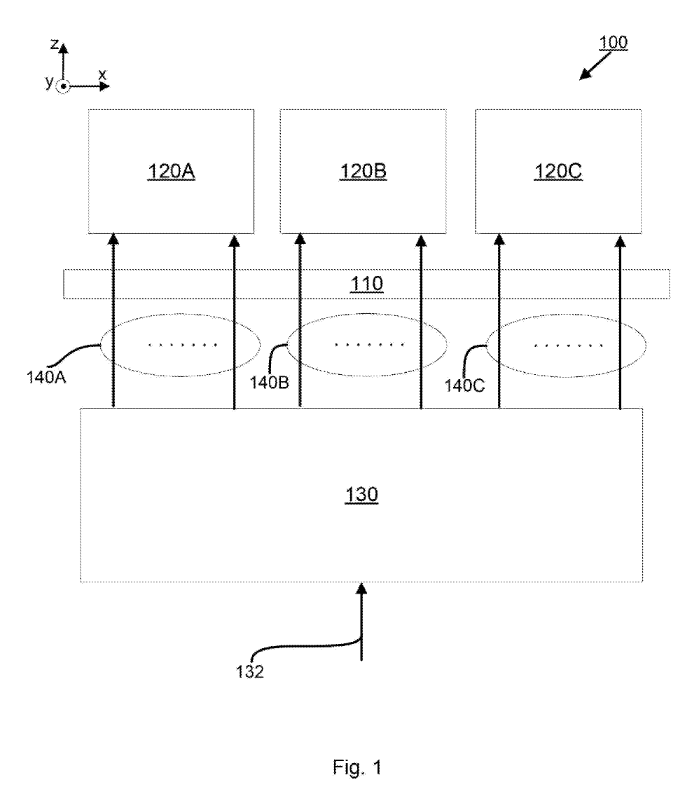

FIG. 1 shows an antenna 100 having a ground plane 110, antenna arrays 120A, 120B, 120C on one side of the ground plane 110, and a feed network 130 on the other side of the ground plane 110. The ground plane 110 is made of an electrically conductive material, such as copper, aluminum, etc., in order to restrain the radiation of the antenna arrays 120A,120B and 120C in the upper half space (i.e., z>0). The ground plane 110 also reduces the amount of radiation at the back of the antenna 100, where the feed network 130 is located (i.e., in the -z direction).

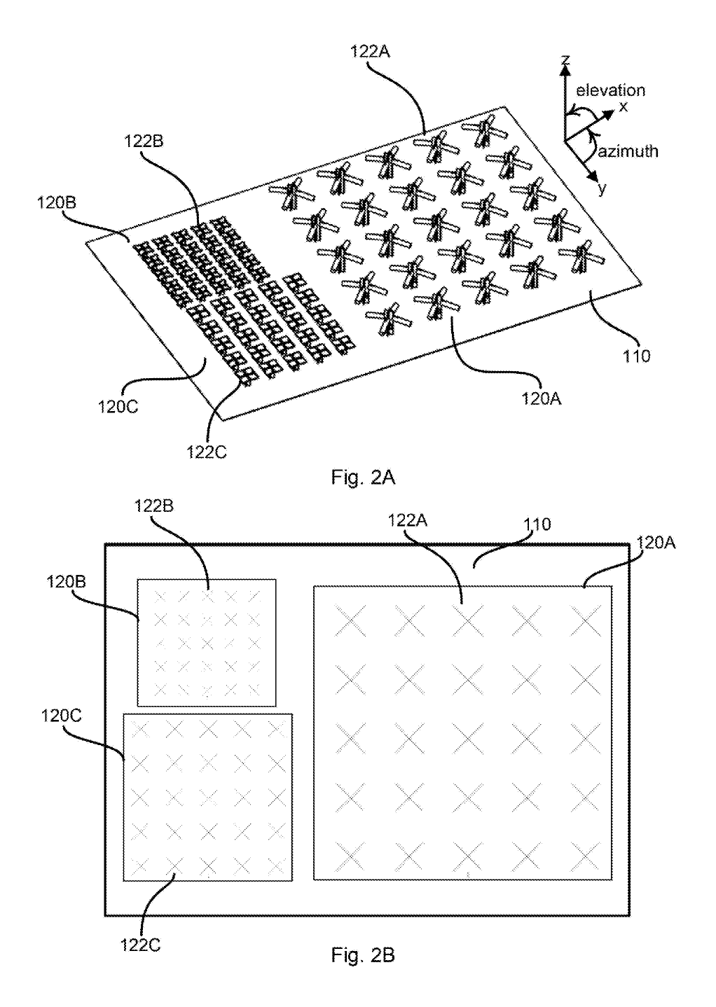

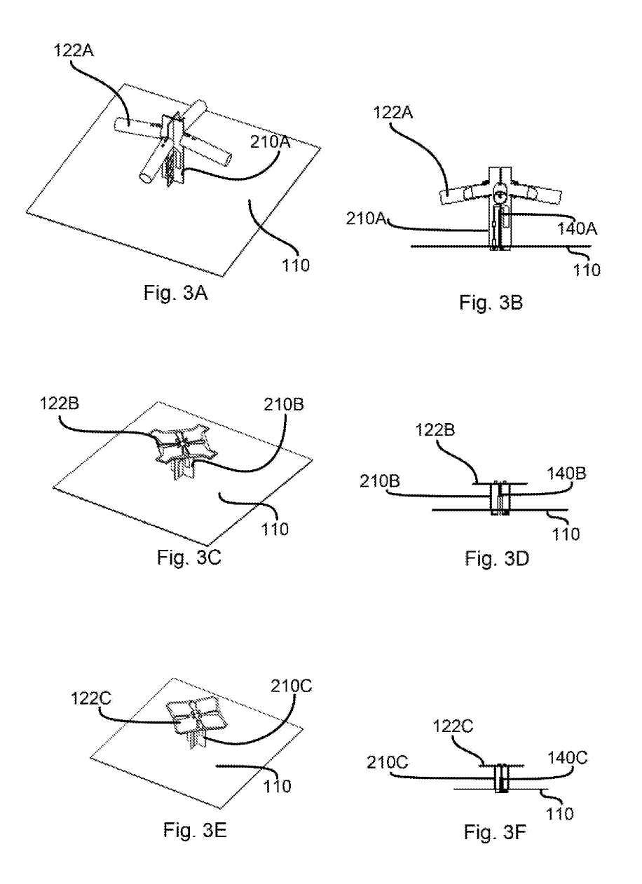

Each of the antenna arrays 120A, 120B, and 120C, which are collectively referred to as antenna arrays 120 hereinafter, is fed by the feed network 130 through the ground plane 110 and produces a dual polarization radiation beam. Each array 120 also generates a rectangular radiation pattern with a half-power beamwidth of 50 degrees in both the azimuth and elevation planes, which is effectively a square radiation pattern. The antenna arrays 120 are described further in relation to FIGS. 2A and 2B and 3A to 3F.

When the antenna 100 is transmitting, the feed network 130 receives radio-frequency (RF) signals in separate, multiple frequency bands at a feed interface 132. Alternatively, the feed network 130 may receive RF signals in the multiple frequency bands at multiple feed interfaces (not shown), where each feed interface receives RF signals in each of the multiple frequency bands. The feed network 130 then distributes the received RF signals to sets of antenna feeds 140A, 140B, and 140C, which are collectively referred to as the sets of antenna feeds 140 hereinafter. Each set of antenna feeds 140 provides RF signals in one of the multiple frequency bands to a respective one of the, arrays 120. For example, antenna feeds 140A, 140B, 140C provide RF signals to antenna arrays 120A, 120B, 120C, respectively, where the RF signals in different frequency bands are provided to the respective arrays 120A, 120B, 120C.

When the antenna 100 is receiving, the feed network 130 receives RF signals from the antenna arrays 120 in multiple frequency bands, and combines the multiple frequency bands to the feed interface 132. Alternatively, tire feed network 130 has multiple feed interfaces such that the received RF signals in the multiple frequency bands do not need to be combined. In this alternative implementation, each of the frequency bands is provided to a separate feed interface (not shown).

When in use, the antenna 100 is placed on, or affixed to, ceilings or roofs of a stadium so that the rectangular radiation beam of the antenna 100 is directed downward to illuminate a section of mobile users in the stadium. Each section of mobile users may correspond to a seat bay in the stadium. However, the size of the area covered by a stadium antenna depends on its distance from the seating, so how many seating bays can be covered by one antenna may vary. The rectangular radiation pattern also provides sharp cut-offs at the edges of the radiation pattern to provide minimum interference between adjacent illuminated sections. Such a defined radiation pattern with sharp cut-offs allows efficient sector planning of placements of the antennas 100 at the stadium.

The antenna 100 also produces low side- and back-lobes to minimize the interference between adjacent antennas 100 and improve the quality of service of the wireless communication, Less interference between adjacent antennas 100 reduces the size of soft handover zones and also improves the signal-to-interference-and-noise ratio (SINR) of the wireless service, The maximum achievable data throughput is therefore increased, resulting in improved user experience.

The antenna 100 provides MEMO functionalities through the dual polarization radiation beam, which provides as much as twice the capacity compared to a single polarization antenna. The additional polarization effectively provides an additional wireless channel, which is known as polarisation diversity. High isolation—better than 30 dB—between the polarizations also provides minimum interference between the signals on orthogonal polarizations of the antenna 100.

Alternatively, the additional polarization can be used to improve quality of coverage by minimising multipath fading of signal within the beam coverage area. That is, the antenna 100 can be used to transmit or receive multiple versions of a signal with dual polarisation to minimise multipath fading and avoid co-channel interference. Such a performance improvement is known as “diversity gain” Within the antenna field.

The antenna 100 supports multiple frequency bands, capable of supporting multiple wireless telecommunication standards such as 2G, 3G, 4G and 3GPP Long Term Evolution (LTE).

In the example shown, the antenna 100 is capable of radiating in three separate frequency bands of: 790 MHz to 960 MHz 1710 MHz to 2170 MHz, and 2300 MHz to 2690 MHz. However, the antenna 100 can be designed to radiate in as little as two separate frequency bands or as many frequency bands as required.

FIGS. 2A and 2B are perspective and top plan views, respectively, of the antenna arrays 120. Each of the antenna arrays 120 operates in one frequency band. The antenna arrays 120A, 120B, and 1200 have a number of dual polarization radiating elements 122A, 122B, and 122C, respectively. The radiating elements 122A, 1228, and 122C are collectively referred to hereinafter as the radiating elements 122. in this example, each of the arrays 120 has dimensions of 5 by 5 radiating elements 122. However, arrays 120 of larger dimensions can be used.

FIGS. 3A and 3B show a perspective and side views, respectively, of the radiating elements 122A. Similarly, FIGS. 3C and 3D area perspective and side views, respectively, of the radiating elements 122B, while FIGS. 3E and 3F are a perspective and side views, respectively, of the radiating elements 122C. Each of the radiating elements 122A, 122B, 122C is suspended above the ground plane 110 via a suspension element 210A, 2108, 210C, respectively. The suspension elements 210A, 210B, 210C are collectively referred to hereinafter as the suspension element 210. Each of the suspension elements 210 comprises or is made of a material of low electrical conductivity, such as plastic, FR4, and Mercurywave, upon which are printed electrically conductive traces forming transmission lines feeding the radiating element. The suspension element 210 transforms the standard 50 ohm impedance to dipole impedance, providing an impedance matching circuit. Besides acting as an impedance matching circuit, the suspension element 210 is also a BALD A to provide the dipole with a balanced signal, The height of the element 210 is usually optimised to provide the largest impedance bandwidth, but can also be varied to adjust the radiation beamwidth.

Each of the radiating elements 122 has two dipoles placed transversely relative to each other (i.e., crossed dipoles) to provide the dual polarization. The centres of the dipoles are fed by the antenna feeds 140. Each dipole is designed to operate at different frequency bands and thus, as can be seen from FIGS. 3A to 3F, has different size according to the operating frequency bands of the particular dipole. For example, the radiating elements 120A, 120B, and 120C may be 143 mm, 65 mm, and 75 mm, respectively.

Alternatively, each of the radiating elements 122 can be a dual polarization patch,

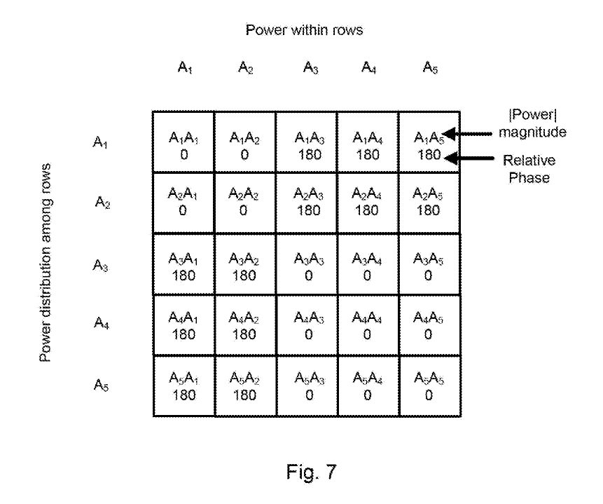

To provide the rectangular radiation pattern, the right amplitudes and phase distribution within the 5×5 array must be provided. In FIG. 7, the term “AA” in each of the array elements represents the magnitude of the power at an element ,and the term s “0” and “180” are the respective phase (in degrees) in that array element. If the terms AiAj and Pij denote the amplitude and the phase of the signal fed into the element at the ith row and jth column, the absolute value of Aij is Ri·Rj (i=1,5;j=1,5). Ri is the magnitude of the signal output at the ith port of each network. The phase Pij (i=1,2j=1,2)=0° and Pij (i=3,5;j=3,5)=0°, and the phase of all the other are elements are 180°.

The arms of the dipoles operating in the lowest frequency band are angled downward in order to increase the F/B ratio. The dipoles may be angled down, not only near the edges of the ground plane, but in all of the elements in the lowest frequency band array. This may be done mainly to improve the front-to-back ratio of the low frequency band pattern. Improved front-to-back minimizes the interference with other sectors. The remaining radiating elements 122B and 122C, which operate at higher frequency bands, do not have such problems.

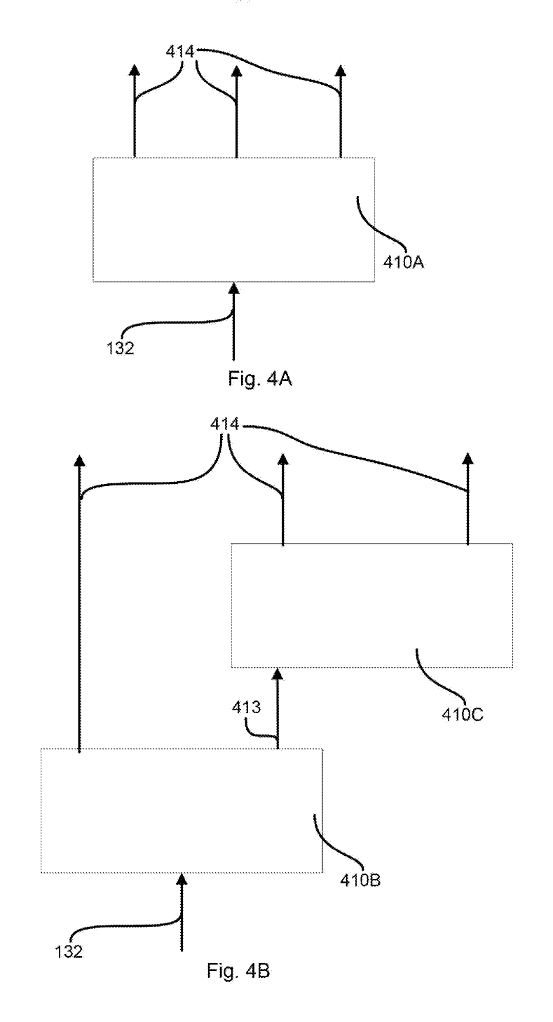

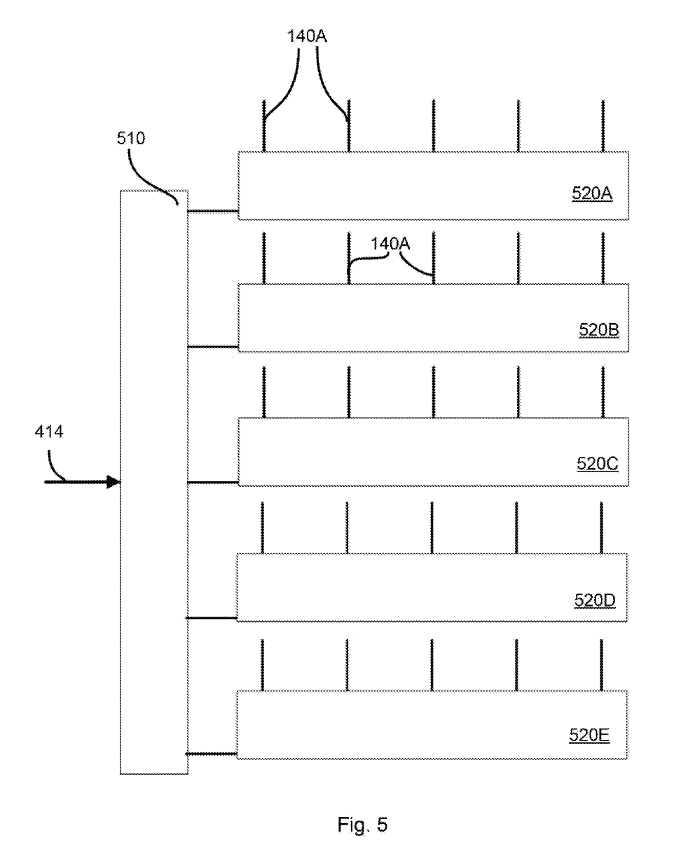

FIGS. 4A and 4B show different implementations of a first part of the feed network 130, while FIG. 5 shows a second part of the feed network 130. The first part of the feed network 130 enables RE signals in multiple frequency band to be divided into separate frequency bands. If the alternative feed network (as described in paragraph [0018] above) of having multiple feed interfaces is used, the first part of the feed network would not be required. The second part of the feed network 130 enables the RF signals in different frequency bands to be distributed to the sets of antenna feeds 140, so that the RF signals can be fed to the respective antenna arrays 120.

FIG. 4A is one implementation of a first part of the feed network 130 having a triplexer 410A, which is capable of separating or combining RF signals in three frequency bands. The triplexer 410A has the feed interface 132 and three output interfaces 414. When the antenna 100 is transmitting, the triplexer 410A receives RF signals in three frequency bands at the feed interface 132 and separates the RF signals in each of the three frequency bands into each of the output interfaces 414. When the antenna 100 is receiving, the triplexer 410A receives RF signals in each of the three frequency bands into each of the output interfaces 414 and outputs the combined RF signals in the three frequency bands to the feed interface 132.

FIG. 4B shows another implementation where the triplexer 410A is replaced with two diplexers 410B and 410C. When the antenna 100 is transmitting, the diplexer 410B receives RE signals in three frequency bands (for example, the bands described in herein above) at the feed interface 132 and separates the RF signals into two bands. The output interface 414 of the diplexer 410B outputs the RF signals at 790 MHz to 960 MHz, while the output interface 413 outputs the RF signals at 1710 MHz to 2690 MHz to the diplexer 410C. The diplexer 410C then separates and presents the remaining two frequency bands 1710 MHz to 2170 MHz and 2300 MHz to 2690 MHz at the output interfaces 414 of the diplexer 410C. The opposite operation, as described in paragraph [0033] above, occurs when the antenna 100 is receiving.

FIG. 5 shows the second part of the feed network 130, having power dividers 510, 520A, 520B, 520C, 520D, and 520E, operating in one frequency band for feeding one of the arrays 120. As shown in FIGS. 2A and 2B, the arrays 120 in this example have a dimension of 5 by 5 radiating elements 122. Thus, the RE signals in each frequency band has to be divided into twenty five RF signals of predetermined amplitude and phases to feed the twenty five radiating elements 122 in each array 120.

To divide the RF signals into twenty five RF signals, the power divider 510 receives the RF signals from one of the outputs 414 and divides the received RF signals into five RF signals of predetermined amplitudes and phase distribution. Each of the divided RF signals is, in turn, fed into each of the remaining power dividers 520A, 520B, 520C, 520D, and 520E. Each of the power dividers 520A, 520B, 520C, 520D, and 520E further divides the RF signals into five RF signals of predetermined amplitude and phase distribution to provide the RF signals of required amplitude and phase at each antenna feed of the antenna feeds 140A. Similarly, antenna feeds 140B and 140C have their own corresponding second part of the feed network 130 for feeding the arrays 120B and 120C, respectively, with the amplitude arid phase distribution as stated hereinbefore and in FIG. 7.

The power dividers 510, 520A, 520B, 520C, 520D, and 520E may be constituted from Wilkinson power dividers. Other power dividers may be practiced. Practically, Wilkinson power dividers are preferred due to improved isolation provided between output ports. The power divider 510 forms the radiation beam of the arrays 120 in the elevation plane, while the power dividers 520A, 520B, 5200, 520D, and 520E form the radiation beam of the arrays 120 in the azimuth plane. Basically, in construction, the power dividers 510, 520A-520E are identical. Therefore, the power dividers all provide the same amplitude distribution. To adjust the phase, the cable lengths can be changed.

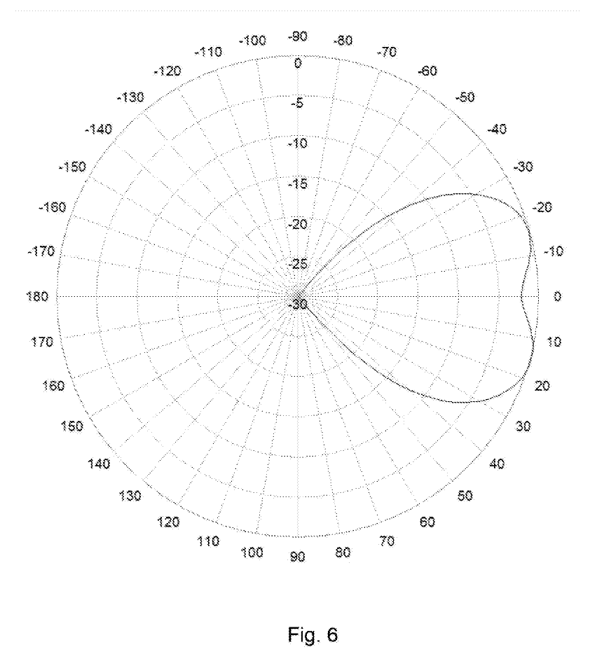

FIG. 6 shows a normalised radiation pattern in the azimuth plane in the frequency band of 790 MHz to 960 MHz. The radiation pattern in the elevation plane in this frequency band is similar. The radiation patterns in the azimuth and elevation planes for the other frequency bands are also similar. Such similarity of the radiation patterns in the multiple frequency bands at the azimuth and elevation planes provide for a square radiation pattern.

As can be seen in FIG. 6, the gain of the rectangular radiation pattern decreases by 25 dB within an angle of 20 degrees (i.e., from about −4 dB at −30 degree to about −30 dB at −50 degree) at the edges of the rectangular radiation pattern. This figure also shows better than 30 dB F/B ratio for the antenna 100.

### INDUSTRIAL APPLICABILITY

The arrangements described are applicable to the wireless communication industries and particularly for the antenna industry. The increased capacity provided by the antenna 100 reduces the need to use additional antennas to increase the capacity of the base station antennas, thereby preventing overload of towers or stadium roofs with weight of additional antennas while also reducing visibility of antennas to users.

The foregoing describes only some embodiments of the present invention, and modifications and/or changes can be made thereto without departing from the scope and spirit of the invention, the embodiments being illustrative and not restrictive,

In the context of this specification, the word “comprising” means “including principally but not necessarily solely” or “having” or “including”, and not “consisting only of”. Variations of the word “comprising”, such as “comprise” and “comprises” have correspondingly varied meanings.

1. An antenna for use in a stadium, comprising:
a ground plane;
a feed network for processing radio-frequency (RF) signals in a plurality of frequency bands to or from two or more sets of antenna feeds, each set of antenna feeds providing or receiving RF signals on a respective one of the plurality of frequency bands;
at least two arrays of radiating elements, each array being fed by a respective one of the two or more sets of antenna feeds of the feed network for producing a rectangular radiation pattern in a respective one of the plurality of frequency bands, each array comprising a plurality of dual polarization radiating elements for producing dual polarization of the rectangular radiation pattern, the at least two arrays of radiating elements being suspended above one side of the ground plane, the feed network feeding the at least two arrays on the other side of the ground plane,
wherein the antenna produces a square radiation pattern in at least one of the frequency bands.

2. The antenna of claim 1, wherein the feed network receives the RF signals via a single feed interface, and the feed network further comprises:
a multiplexer for separating the received RF signals into the plurality of frequency bands; and
sets of power dividers that are fed by the multiplexer, each set of power dividers dividing the received RF signals in each of the plurality of frequency bands into a respective one of the two or more sets of outputs of the feed network.

3. The antenna of claim 1, wherein the radiating elements include dipoles or patches.

4. The antenna of claim 1, wherein each array has a dimension of 5 by 5 radiating elements.

5. The antenna as claimed in claim 3, wherein the radiating elements in the lowest frequency band are dipoles that are angled downward.

6. The antenna of claim 1, wherein the dual polarization produced by each of the at least two arrays is used for path diversity or diversity gain.

7.-8. (canceled)

9. The antenna of claim 1, wherein at least two of the plurality of frequency bands have an isolation between polarizations in band of better than 30 dB.

10. The antenna of claim 1, wherein the antenna has a front to back ratio of better than 30 dB.

11.-12. (canceled)

13. The antenna of claim 1, wherein the antenna includes three arrays of radiating elements for transmitting on three frequency bands.

14. The antenna of claim 1, wherein the plurality of frequency bands are 790 MHz to 960 MHz, 1710 MHz to 2170 MHz, and 2300 MHz to 2690 MHz.

15. An antenna for use in a stadium, comprising:
a ground plane;
a feed network for processing radio-frequency (RF) signals in a plurality of frequency bands to or from two or more sets of antenna feeds, each set of antenna feeds providing or receiving RF signals on a respective one of the plurality of frequency bands;
at least two arrays of radiating elements, each array being fed by a respective one of the two or more sets of antenna feeds of the feed network for producing a rectangular radiation pattern in a respective one of the plurality of frequency bands, each array comprising a plurality of dual polarization radiating elements for producing dual polarization of the rectangular radiation pattern, the at least two arrays of radiating elements being suspended above one side of the ground plane, the feed network feeding the at least two arrays on the other side of the ground plane,
wherein the feed network is configured so that signals fed to the radiating elements in an upper left quadrant of a first array of the at least two arrays have a first phase, signals fed to the radiating elements in a lower right quadrant of the first array have the first phase, signals fed to the radiating elements in an upper right quadrant of the first array have a second phase that is offset by 180 degrees from the first phase, and signals fed to the radiating elements in a lower left quadrant of the first array have the second phase.

16. The antenna of claim 15, wherein the first array is a 5×5 array of twenty-five radiating elements, and the upper left quadrant includes four of the twenty-five radiating elements, the upper right quadrant includes six of the twenty-five radiating elements, the lower left quadrant includes six of the twenty-five radiating elements, and the lower right quadrant includes nine of the twenty-five radiating elements.

17. The antenna of claim 15, wherein the antenna is mounted on a ceiling or roof of the stadium and is directed downwardly to illuminate a section of the stadium.

18. The antenna of claim 15, wherein the antenna produces a square radiation pattern in at least one of the frequency bands.

19. An antenna for use in a stadium, comprising:
a ground plane;
a feed network for processing radio-frequency (RF) signals in a plurality of frequency bands to or from two or more sets of antenna feeds, each set of antenna feeds providing or receiving RF signals on a respective one of the plurality of frequency bands;
first, second and third arrays of radiating elements, each array being fed by a respective one of the two or more sets of antenna feeds of the feed network for producing a rectangular radiation pattern in a respective one of the plurality of frequency bands, each array comprising a plurality of dual polarization radiating elements for producing dual polarization of the rectangular radiation pattern, the first, second and third arrays of radiating elements being suspended above one side of the ground plane, the feed network feeding the first, second and third arrays on the other side of the ground plane,
wherein the first, second and third arrays of radiating elements are not interleaved.

20. The antenna of claim 19, wherein the feed network is configured so that signals fed to the radiating elements in an upper left quadrant of the first array have a first phase, signals fed to the radiating elements in a lower right quadrant of the first array have the first phase, signals fed to the radiating elements in an upper right quadrant of the first array have a second phase that is offset by 180 degrees from the first phase, and signals fed to the radiating elements in a lower left quadrant of the first array have the second phase.

21. The antenna of claim 20, wherein the first array is a 5×5 array of twenty-five radiating elements, and the upper left quadrant includes four of the twenty-five radiating elements, the upper right quadrant includes six of the twenty-five radiating elements, the lower left quadrant includes six of the twenty-five radiating elements, and the lower right quadrant includes nine of the twenty-five radiating elements.

22. The antenna of claim 19, wherein the antenna is mounted on a ceiling or roof of the stadium and is directed downwardly to illuminate a section of the stadium.

23. The antenna of claim 19, wherein the antenna produces a square radiation pattern in at least one of the frequency bands.
